(19) United States
(12) Patent Application Publication
(10) Pub. No.: US 2023/0308256 A1
(43) Pub. Date: Sep. 28, 2023

(54) VEHICLE-MOUNTED DEVICE, ABNORMALITY DETECTING METHOD, AND ABNORMALITY DETECTING PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(72) Inventors: Kazuki KITAGAWA, Yokkaichi-shi, Mie (JP); Kentaro ASHIBE, Yokkaichi-shi, Mie (JP); Yosuke SHIMIZU, Yokkaichi-shi, Mie (JP); Ryo YAMANE, Osaka-shi, Osaka (JP); Akihito IWATA, Osaka-shi, Osaka (JP); Yojiro SUYAMA, Osaka-shi, Osaka (JP); Hirofumi URAYAMA, Osaka-shi, Osaka (JP); Hideki GOTO, Toyota-shi, Aichi (JP); Masashi AMESARA, Toyota-shi, Aichi (JP); Hisashi FURUKAWA, Toyota-shi, Aichi (JP); Shu ISHIZUKA, Toyota-shi, Aichi (JP)

(21) Appl. No.: 18/042,792

(22) PCT Filed: Jul. 30, 2021
(86) PCT No.: PCT/JP2021/028437

§ 371 Date: Feb. 24, 2023

(30) Foreign Application Priority Data
Aug. 25, 2020 (JP) 2020-141305

(51) Int. Cl. H04L 7/00; H04L 67/12; B60R 16/023

(52) U.S. Cl. CPC H04L 7/0033; H04L 67/12; B60R 16/0231

(57) ABSTRACT

Time synchronization is performed between the vehicle-mounted device and another device that is another vehicle-mounted device based on a data propagation delay time between the vehicle-mounted device and the other device. The vehicle-mounted device includes: a processing unit configured to receive, from the other device, request information that requests time information used for updating the propagation delay time, and transmit the time information to the other device; and a detection unit configured to detect an abnormality related to time synchronization, and acquire information regarding the detected abnormality.

### CROSS-REFERENCE TO RELATED APPLICATIONS

This application is the U.S. national stage of PCT/JP2021/028437 filed on Jul. 30, 2021, which claims priority of Japanese Patent Application No. JP 2020-141305 filed on Aug. 25, 2020, the contents of which are incorporated herein.

### TECHNICAL FIELD

The present disclosure relates to a vehicle-mounted device, an abnormality detecting method, and an abnormality detecting program.

### BACKGROUND

The following vehicle-mounted network system is disclosed in JP 2013-168865A. This vehicle-mounted network system includes: a vehicle-mounted control device provided with a memory for storing definition data that defines an implementation-dependent portion of a communication protocol used in the vehicle-mounted network; and a communication protocol issuing device that issues the definition data to the vehicle-mounted control device. When a registration request for allowing the vehicle-mounted control device to join the vehicle-mounted network is received from a registration device for allowing the vehicle-mounted control device to join the vehicle-mounted network, the communication protocol issuing device performs authentication on the registration device, and then creates definition data conforming to implementation in the vehicle-mounted network, and transmits the created definition data to the registration device. The registration device receives the definition data transmitted by the communication protocol issuing device, and requests the vehicle-mounted control device to store the received definition data in the memory. The vehicle-mounted control device receives the definition data from the registration device, stores the definition data in the memory, and, in accordance with the portion defined by the definition data, performs communication over the vehicle-mounted network in compliance with the communication protocol.

Conventionally, techniques have been developed regarding vehicle-mounted networks that include multiple vehicle-mounted devices.

### SUMMARY

A vehicle-mounted device according to the present disclosure includes: a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and a detection unit configured to detect an abnormality related to time synchronization, and acquire information regarding the detected abnormality.

A vehicle-mounted device according to the present disclosure, in which time synchronization is performed between the vehicle-mounted device and another device that is another vehicle-mounted device based on a data propagation delay time between the vehicle-mounted device and the other device, the vehicle-mounted device includes: a processing unit configured to receive, from the other device, request information that requests time information used for updating the propagation delay time, and transmit the time information to the other device; and a detection unit configured to detect an abnormality related to time synchronization, and acquire information regarding the detected abnormality.

An abnormality detecting method performed in a vehicle-mounted device according to the present disclosure includes the steps of transmitting, to another device that is another vehicle-mounted device, request information that requests time information used for updating a data propagation delay time between the vehicle-mounted device and the other device; receiving the time information transmitted from the other device; updating the propagation delay time based on the received time information; performing time synchronization with the other device based on the updated propagation delay time; and detecting an abnormality related to time synchronization, and acquiring information regarding the detected abnormality.

An abnormality detecting method performed in a vehicle-mounted device according to the present disclosure, in which time synchronization is performed between the vehicle-mounted device and another device that is another vehicle-mounted device based on a data propagation delay time between the vehicle-mounted device and the other device, the abnormality detecting method includes the steps of receiving, from the other device, request information that requests time information used for updating the propagation delay time; transmitting the time information to the other device; and detecting an abnormality related to time synchronization, and acquiring information regarding the detected abnormality.

An abnormality detecting program used in a vehicle-mounted device according to the present disclosure causes a computer to function as: a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and a detection unit configured to detect an abnormality related to time synchronization, and acquire information regarding the detected abnormality.

An abnormality detecting program used in a vehicle-mounted device according to the present disclosure, in which time synchronization is performed between the vehicle-mounted device and another device that is another vehicle-mounted device based on a data propagation delay time between the vehicle-mounted device and the other device, the abnormality detecting program causes a computer to function as: a processing unit configured to receive, from the other device, request information that requests time information used for updating the propagation delay time, and transmit the time information to the other device; and a detection unit configured to detect an abnormality related to time synchronization, and acquire information regarding the detected abnormality.

One aspect of the present disclosure can be realized not only as a vehicle-mounted device that includes such characteristic processing units, but also as a semiconductor integrated circuit that realizes a part or the entirety of the vehicle-mounted device, or a vehicle-mounted network system that includes the vehicle-mounted device.

For example, the data propagation delay time between vehicle-mounted devices in a vehicle-mounted network is periodically updated in accordance with a protocol defined by a standard such as IEEE 802.1, and the updated propagation delay time is used in order to perform time synchronization among the vehicle-mounted devices.

However, an abnormality related to time synchronization, such as a sudden change in the data propagation delay time between vehicle-mounted devices, can possibly occur, and in such a case, a problem such as a decrease in the precision of time synchronization may occur.

The present disclosure has been made to solve the aforementioned problems, and an object of the present disclosure is to provide a vehicle-mounted device, an abnormality detecting method, and an abnormality detecting program capable of more stably performing time synchronization between vehicle-mounted devices.

With the present disclosure, time synchronization between vehicle-mounted devices can be performed more stably.

### BRIEF DESCRIPTION OF THE DRAWINGS

FIG. 1 is a diagram showing the configuration of a vehicle-mounted network system according to an embodiment of the present disclosure.

FIG. 2 is a diagram showing a configuration of the switching device according to this embodiment of the present disclosure.

FIG. 3 is a diagram illustrating a configuration of the master functional unit according to this embodiment of the present disclosure.

FIG. 4 is a diagram for describing a propagation delay time updating method performed by the switching device according to this embodiment of the present disclosure.

FIG. 5 is a diagram illustrating a configuration of the slave functional unit according to this embodiment of the present disclosure.

FIG. 6 is a diagram for describing a propagation delay time updating method performed by the slave functional unit according to this embodiment of the present disclosure.

FIG. 7 is a diagram illustrating an example of the case where a sudden change occurs in the data propagation delay time between the master functional unit and the switching device according to this embodiment of the present disclosure.

FIG. 8 is a diagram illustrating an example of a case where an interruption has occurred in data transmitted between a functional unit and the switching device according to this embodiment of the present disclosure.

FIG. 9 is a diagram showing an example of the error code list stored in the storage units of the switching device and the functional unit according to this embodiment of the present disclosure.

FIG. 10 is a diagram showing a sequence of updating of the propagation delay time and detection of an abnormality related to time synchronization, performed by a plurality of vehicle-mounted devices in the vehicle-mounted network system according to this embodiment of the present disclosure.

FIG. 11 is a diagram showing a sequence of time correction performed by a plurality of vehicle-mounted devices in the vehicle-mounted network system according to this embodiment of the present disclosure.

### DETAILED DESCRIPTION OF PREFERRED EMBODIMENTS

First, the details of an embodiment of the present disclosure are listed and described.

### First Aspect

In accordance with a first aspect, a vehicle-mounted device according to an embodiment of the present disclosure includes: a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and a detection unit configured to detect an abnormality related to time synchronization, and acquire information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably.

### Second Aspect

In a second aspect, a vehicle-mounted device according to an embodiment of the present disclosure, in which time synchronization is performed between the vehicle-mounted device and another device that is another vehicle-mounted device based on a data propagation delay time between the vehicle-mounted device and the other device, the vehicle-mounted device includes: a processing unit configured to receive, from the other device, request information that requests time information used for updating the propagation delay time, and transmit the time information to the other device; and a detection unit configured to detect an abnormality related to time synchronization, and acquire information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably. Also, with the configuration for detecting an abnormality related to time synchronization in the vehicle-mounted device that is the transmission source of time information, that is to say in the vehicle-mounted device that holds the reference time in the vehicle-mounted network, it is possible to more reliably detect an abnormality related to time synchronization.

### Third Aspect

In a third aspect, the vehicle-mounted device further includes a recording unit configured to store, in a storage unit, the information regarding the abnormality detected by the detection unit.

In this manner, with a configuration in which information regarding an abnormality that has occurred in a vehicle-mounted device is stored in the vehicle-mounted device, it is possible to recognize the occurrence of an abnormality without another device other than the vehicle-mounted device being used for information transmission, and it is possible to more quickly take a measure such as performing processing to resolve the cause of the abnormality.

### Fourth Aspect

In a fourth aspect, the detection unit detects, as the abnormality related to time synchronization, an abnormality related to transmission of at least either the request information or the time information.

According to this configuration, it is possible to detect a change in the propagation delay time of a message used for time synchronization, for example, thus making it possible to more reliably detect an abnormality related to time synchronization.

### Fifth Aspect

In a fifth aspect, the detection unit detects, as the abnormality related to time synchronization, a delay or an interruption in transmission of at least either the request information or the time information.

Here, even in the case where a delay or an interruption temporarily occurs in message transmission due to communication congestion or the like, if the cause is resolved, message transmission is performed normally, and information regarding the abnormality is not recorded, for example, and therefore an administrator or the like may not be able to be aware of the abnormality. If the abnormality is thus not recognized, it is not possible to take a measure to resolve the cause of the abnormality, and thus there is a possibility that a similar abnormality will occur again. In contrast, according to the configuration described above, even in the case where there is a possibility that an abnormality occurs temporarily and is then resolved, the abnormality can be detected, and information regarding the abnormality can be recorded, for example, thus making it possible to take a measure such as performing processing to resolve the cause of the abnormality.

### Sixth Aspect

In a sixth aspect, an abnormality detecting method performed in a vehicle-mounted device according to an embodiment of the present disclosure includes the steps of transmitting, to another device that is another vehicle-mounted device, request information that requests time information used for updating a data propagation delay time between the vehicle-mounted device and the other device; receiving the time information transmitted from the other device; updating the propagation delay time based on the received time information; performing time synchronization with the other device based on the updated propagation delay time; and detecting an abnormality related to time synchronization, and acquiring information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably.

### Seventh Aspect

In a seventh aspect, an abnormality detecting method performed in a vehicle-mounted device according to an embodiment of the present disclosure, in which time synchronization is performed between the vehicle-mounted device and another device that is another vehicle-mounted device based on a data propagation delay time between the vehicle-mounted device and the other device, the abnormality detecting method includes the steps of receiving, from the other device, request information that requests time information used for updating the propagation delay time; transmitting the time information to the other device; and detecting an abnormality related to time synchronization, and acquiring information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably. Also, with the configuration for detecting an abnormality related to time synchronization in the vehicle-mounted device that is the transmission source of time information, that is to say in the vehicle-mounted device that holds the reference time in the vehicle-mounted network, it is possible to more reliably detect an abnormality related to time synchronization.

### Eighth Aspect

In an eighth aspect, an abnormality detecting program used in a vehicle-mounted device according to an embodiment of the present disclosure causes a computer to function as: a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and a detection unit configured to detect an abnormality related to time synchronization, and acquire information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably.

### Ninth Aspect

In a ninth aspect, an abnormality detecting program used in a vehicle-mounted device according to an embodiment of the present disclosure, in which time synchronization is performed between the vehicle-mounted device and another device that is another vehicle-mounted device based on a data propagation delay time between the vehicle-mounted device and the other device, the abnormality detecting program causes a computer to function as: a processing unit configured to receive, from the other device, request information that requests time information used for updating the propagation delay time, and transmit the time information to the other device; and a detection unit configured to detect an abnormality related to time synchronization, and acquire information regarding the detected abnormality.

In this way, with the configuration for detecting an abnormality related to time synchronization, it is possible to recognize the occurrence of an abnormality, and to take a measure such as quickly performing processing to resolve the cause of the abnormality. Accordingly, time synchronization between vehicle-mounted devices can be performed more stably. Also, with the configuration for detecting an abnormality related to time synchronization in the vehicle-mounted device that is the transmission source of time information, that is to say in the vehicle-mounted device that holds the reference time in the vehicle-mounted network, it is possible to more reliably detect an abnormality related to time synchronization.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Configuration and Basic Operation

### Overall Configuration

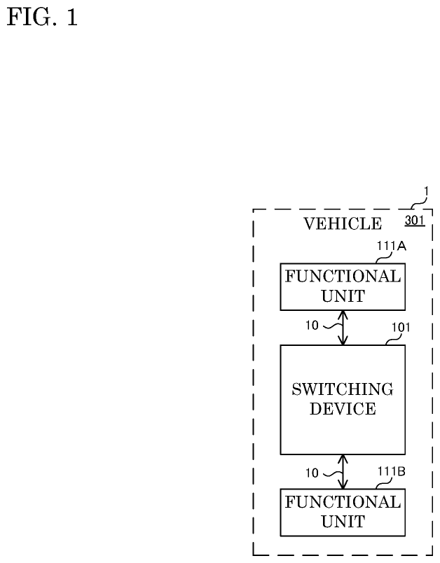

FIG. 1 is a diagram showing the configuration of a vehicle-mounted network system according to an embodiment of the present disclosure. As shown in FIG. 1, a vehicle-mounted network system 301 is provided in a vehicle 1, and includes a switching device 101 and a plurality of functional units 111. FIG. 1 shows an example in which two functional units 111A and 111B are provided as the functional units 111. The switching device 101 and the functional units 111 are each a vehicle-mounted device such as an ECU (Electronic Control Unit).

The switching device 101 is connected to the functional units 111 via Ethernet (registered trademark) cables 10, for example, and is capable of communicating with the functional units 111 connected thereto.

Specifically, the switching device 101 performs relay processing for relaying data from one functional unit 111 to another functional unit 111. Information is exchanged between the switching device 101 and the functional units 111 using Ethernet frames in which IP packets are stored, for example.

Examples of the functional units 111 include an external communication ECU, a sensor, a camera, a navigation device, an automatic driving processing ECU, an engine control device, an AT (Automatic Transmission) control device, an HEV (Hybrid Electric Vehicle) control device, a brake control device, a chassis control device, a steering control device, and an instrument display control device.

### Switching Device and Master Functional Unit

### Configuration of Switching Device

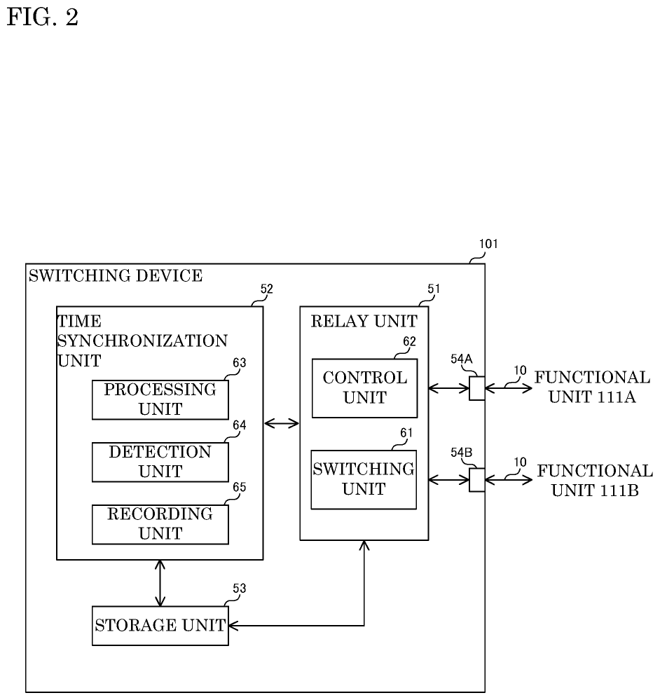

FIG. 2 is a diagram showing a configuration of the switching device according to this embodiment of the present disclosure. As shown in FIG. 2, the switching device 101 includes a relay unit 51, a time synchronization unit 52, a storage unit 53, and a plurality of communication ports 54. The relay unit 51 and the time synchronization unit 52 are each realized by a processor such as a CPU (Central Processing Unit) or a DSP (Digital Signal Processor), for example. The storage unit 53 is a non-volatile memory, for example.

The relay unit 51 includes a switching unit 61 and a control unit 62. The time synchronization unit 52 includes a processing unit 63, a detection unit 64, and a recording unit 65.

### Relay Processing of Switching Device

The communication ports 54 are terminals to which the Ethernet cables 10 can be connected, for example. Note that the communication ports 54 may be integrated circuit terminals. Each of the communication ports 54 is connected to one of the functional units 111 via an Ethernet cable 10. In this example, a communication port 54A is connected to the functional unit 111A, and a communication port 54B is connected to the functional unit 111B.

The storage unit 53 stores an address table Ta1 that indicates the correspondence between the port numbers of the communication ports 54 and the MAC (Media Access Control) addresses of connected devices.

The switching unit 61 relays data between other vehicle-mounted devices. Specifically, when an Ethernet frame transmitted from one functional unit 111 is received via the communication port 54 that corresponds to that functional unit 111, the switching unit 61 performs relay processing for the received Ethernet frame.

More specifically, the switching unit 61 references the address table Ta1 stored in the storage unit 53 and specifies the port number that corresponds to the destination MAC address included in the received Ethernet frame. The switching unit 61 then transmits the received Ethernet frame via the communication port 54 that has the specified port number.

The switching device 101 updates a data propagation delay time Td1 between the master functional unit 111 and the switching device 101. Here, the functional unit 111A is the master functional unit 111, and the functional unit 111B is the slave functional unit 111. The functional unit 111A holds the reference time in the vehicle-mounted network system 301.

### Configuration of Master Functional Unit

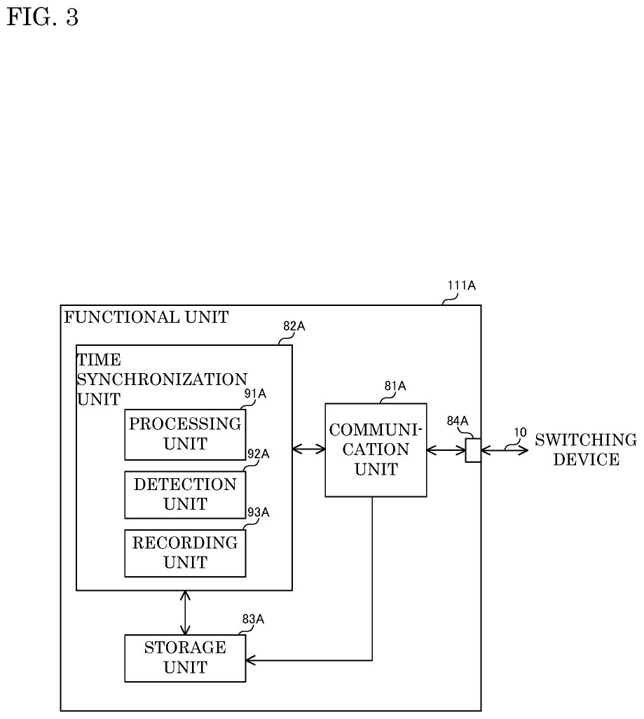

FIG. 3 is a diagram illustrating a configuration of the master functional unit according to this embodiment of the present disclosure. As shown in FIG. 3, the master functional unit 111A includes a communication unit 81A, a time synchronization unit 82A, a storage unit 83A, and a communication port 84A The communication unit 81A and the time synchronization unit 82A are each realized by a processor such as a CPU or a DSP, for example. The storage unit 83A is a non-volatile memory, for example.

The time synchronization unit 82A includes a processing unit 91A, a detection unit 92A and a recording unit 93A. The communication port 84A is a terminal to which an Ethernet cable 10 can be connected, for example. Note that the communication port 84A may be a terminal of an integrated circuit, for example. The communication port 84A is connected to the switching device 101 via an Ethernet cable 10.

### Updating of Data Propagation Delay Time Between Master Functional Unit and Switching Device

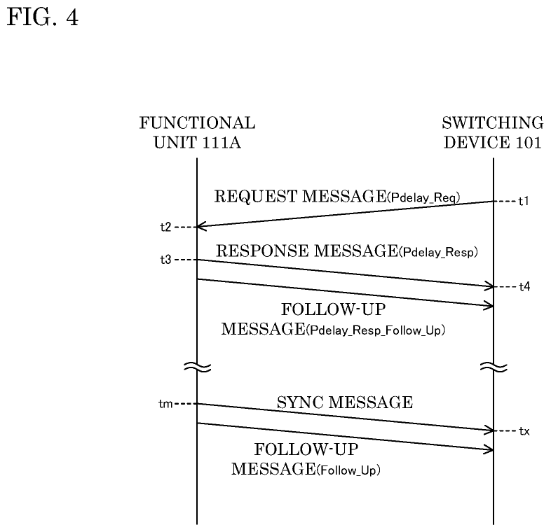

FIG. 4 is a diagram for describing a propagation delay time updating method performed by the switching device according to this embodiment of the present disclosure.

As shown in FIGS. 2 to 4, the processing unit 63 of the switching device 101 periodically or irregularly updates the data propagation delay time Td1 between the functional unit 111A and the switching device 101. More specifically, the processing unit 63 transmits request information (Pdelay_Req) for requesting time information used for updating the propagation delay time Td1, to the functional unit 111A via the relay unit 51 and the communication port 54A. Hereinafter, the request information will also be referred to as a “request message”.

The communication unit 81A of the functional unit 111A receives the request message transmitted from the switching device 101, via the communication port 84A, and outputs the received request message to the time synchronization unit 82A.

The processing unit 91A of the time synchronization unit 82A receives the request message from the communication unit 81A, and outputs time information (Pdelay_Resp) to the communication unit 81A in response to the request message. The communication unit 81A transmits the time information received from the processing unit 91A to the switching device 101 via the communication port 84A. At this time, the processing unit 91A also transmits a reception time t2 of the request message in the time information. Hereinafter, the time information will also be referred to as a “response message”.

After transmitting the response message, the processing unit 91A outputs a follow-up message (Pdelay_Resp_Follow_Up) that includes a transmission time t3 of the response message, to the communication unit 81A. The communication unit 81A transmits the follow-up message received from the processing unit 91A to switching device 101 via the communication port 84A.

The response message and the follow-up message that were transmitted from the functional unit 111A are received by the control unit 62 of the switching device 101 via the communication port 54A. The control unit 62 then notifies the time synchronization unit 52 of the time t2 included in the response message and the time t3 included in the follow-up message.

The control unit 62 also notifies the time synchronization unit 52 of a transmission time t1 of the request message and a reception time t4 of the response message. More specifically, the switching device 101 includes a counter (not shown). The control unit 62 notifies the time synchronization unit 52 of the count value of the counter at the timing of transmission of the request message, as the transmission time t1. Also, the control unit 62 notifies the time synchronization unit 52 of the count value of the counter at the timing of reception of the response message, as the reception time t4.

The processing unit 63 of the time synchronization unit 52 calculates the data propagation delay time Td1 between the functional unit 111A and the switching device 101 based on the times t1, t2, t3, and t4 notified from the control unit 62. Specifically, the processing unit 63 calculates the propagation delay time Td1=((t4−t1)−(t3−t2))/2. Then, the processing unit 63 updates the propagation delay time Td1 stored in the storage unit 53 to the newly calculated propagation delay time Td1.

### Correction of Time in Switching Device

The processing unit 91A of the functional unit 111A periodically or irregularly outputs a Sync message to the communication unit 81A. The communication unit 81A transmits the Sync message received from the processing unit 91A to the switching device 101 via the communication port 84A. After transmitting the Sync message, the processing unit 91A also outputs a follow-up message (Follow_Up) that includes a transmission time tm of the Sync message to the communication unit 81A. The communication unit 81A transmits the follow-up message received from the processing unit 91A to the switching device 101 via the communication port 84A.

The control unit 62 of the switching device 101 receives the Sync message and the follow-up message that were transmitted from the functional unit 111A via the communication port 54A. The control unit 62 then notifies the time synchronization unit 52 of the time tm included in the follow-up message. Also, the control unit 62 notifies the time synchronization unit 52 of the count value of the counter at the timing of reception of the Sync message, as a reception time tx of the Sync message.

The processing unit 63 of the time synchronization unit 52 performs time synchronization with the functional unit 111A based on the times tm and tx notified from the control unit 62 and the propagation delay time Td1 stored in the storage unit 53. More specifically, based on the times tm and tx and the propagation delay time Td1, the processing unit 63 calculates a time difference Tx1=tm−Td1−tx, which is the difference between the time in the functional unit 111A and the time in the switching device 101.

The processing unit 63 corrects the time in the switching device 101 using the calculated time difference Tx1. Accordingly, time synchronization is achieved between the functional unit 111A and the switching device 101.

### Slave Functional Unit

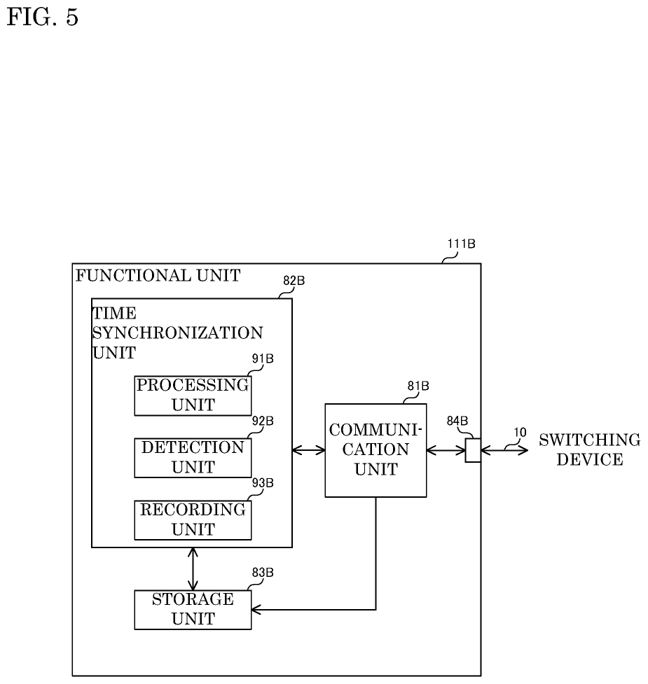

FIG. 5 is a diagram illustrating a configuration of the slave functional unit according to this embodiment of the present disclosure. As shown in FIG. 5, the slave functional unit 111B includes a communication unit 81B, a time synchronization unit 82B, a storage unit 83B, and a communication port 84B. The communication unit 81B and the time synchronization unit 82B are each realized by a processor such as a CPU or a DSP, for example. The storage unit 83B is a non-volatile memory, for example.

The time synchronization unit 82B includes a processing unit 91B, a detection unit 92B, and a recording unit 93B. The communication port 84B is a terminal to which an Ethernet cable 10 can be connected, for example. Note that the communication port 84B may be a terminal of an integrated circuit, for example. The communication port 84B is connected to the switching device 101 via an Ethernet cable 10.

Hereinafter, the storage unit 83A of the functional unit 111A and the storage unit 83B of the functional unit 111B will each also be referred to as “the storage unit 83”. Also, the detection unit 92A of the functional unit 111A and the detection unit 92B of the functional unit 111B will each also be referred to as the “detection unit 92”. Moreover, the recording unit 93A of the functional unit 111A and the recording unit 93B of the functional unit 111B will each also be referred to as the “recording unit 93”.

### Updating of Data Propagation Delay Time Between Switching Device and Slave Functional Unit

The slave functional unit 111B updates a data propagation delay time Td2 between the switching device 101 and the slave functional unit 111B.

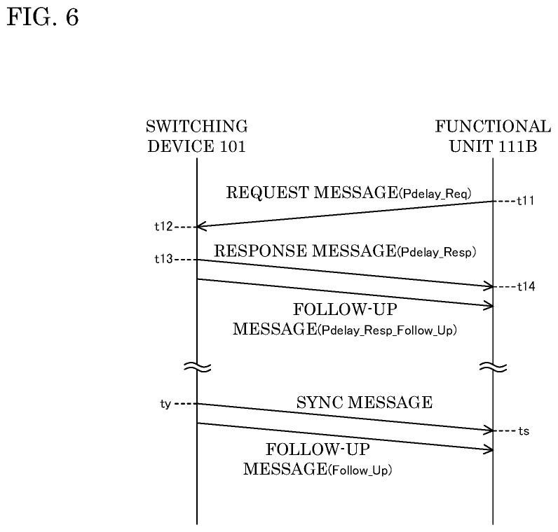

FIG. 6 is a diagram for describing a propagation delay time updating method performed by the slave functional unit according to this embodiment of the present disclosure.

More specifically, as shown in FIGS. 5 and 6, the processing unit 91B of the slave functional unit 111B periodically or irregularly performs updating of the data propagation delay time Td2 between the switching device 101 and the functional unit 111B, similarly to the processing unit 63 of the switching device 101 shown in FIG. 2. More specifically, the processing unit 91B transmits a request message for requesting time information used for updating the propagation delay time Td2, to the switching device 101 via the communication unit 81B and the communication port 84B.

When the request message transmitted from the functional unit 111B is received via the communication port 54B, the control unit 62 of the switching device 101 outputs the request message to the processing unit 63.

Upon receiving the request message from control unit 62, the processing unit 63 transmits a response message in response to the request message, to the functional unit 111B via the relay unit 51 and the communication port 54B. At this time, the processing unit 63 also transmits a reception time t22 of the request message in the response message.

After transmitting the response message, the processing unit 63 also transmits a follow-up message that includes a transmission time t13 of the response message to the functional unit 111B via the relay unit 51 and the communication port 54B.

The response message and the follow-up message that were transmitted from the switching device 101 are received by the communication unit 81B of the functional unit 111B via the communication port 84. The communication unit 81B then notifies the time synchronization unit 82B of a time t12 included in the response message and the time t13 included in the follow-up message.

The communication unit 81B also notifies the time synchronization unit 82B of a transmission time t11 of the request message and a reception time t14 of the response message. More specifically, functional unit 111B includes a counter (not shown). The communication unit 81B notifies the time synchronization unit 82B of the count value of the counter at the timing of transmission of the request message, as the transmission time t11. Also, the communication unit 81B notifies the time synchronization unit 82B of the count value of the counter at the timing of reception of the response message, as the reception time t14.

The processing unit 91B of the time synchronization unit 82B calculates the data propagation delay time Td2 between the switching device 101 and the functional unit 111B based on the times t11, t12, t13, and t14 notified from the communication unit 81B. Specifically, the processing unit 91B calculates the propagation delay time Td2=((t14−t11)−(t13−t12))/2. The processing unit 91B then updates the propagation delay time Td2 stored in the storage unit 83 to the newly calculated propagation delay time Td2.

### Correction of Time in Slave Functional Unit

The processing unit 63 of the switching device 101 periodically or irregularly transmits a Sync message to the slave functional unit 111B. After transmitting the Sync message, the processing unit 63 also transmits a follow-up message that includes a transmission time ty of the Sync message to the functional unit 111B.

The communication unit 81B of the functional unit 111B receives the Sync message and the follow-up message that were transmitted from the switching device 101, via the communication port 84B. The communication unit 81B then notifies the time synchronization unit 82B of the time ty included in the follow-up message. The communication unit 81B also notifies the time synchronization unit 82B of the count value of the counter at the timing of reception of the Sync message, as a reception time ts of the Sync message.

The processing unit 91B of the time synchronization unit 82B performs time synchronization with the switching device 101 based on the times ty and ts notified from the communication unit 81B and the propagation delay time Td2 stored in the storage unit 83B. More specifically, the processing unit 91B calculates a time difference Tx2=ty−Td2−ts, which is the difference between the time in the switching device 101 and the time in the functional unit 111B. The processing unit 91B then corrects the time in the functional unit 111B using the calculated time difference Tx2.

Here, when time synchronization is achieved between the master functional unit 111A and the switching device 101, the time ty included in the follow-up message transmitted from the switching device 101 to the functional unit 111B is synchronized with the time in the functional unit 111A. For this reason, the processing unit 91B of the functional unit 111B performs time correction to achieve time synchronization between the functional unit 111B and the switching device 101, and as a result, time synchronization is achieved between the functional unit 111B and the functional unit 111A.

### Detection of Abnormality Related to Time Synchronization

The detection unit 64 of the switching device 101 and the detection unit 92 of the functional unit 111 detect an abnormality related to time synchronization and acquire information about the detected abnormality. Examples of an abnormality related to time synchronization include an abnormality in the transmission of at least either a request message or a response message, and a timestamp function abnormality. Detection performed by the detection unit 64 and the detection unit 92 will be described in detail below.

### (a) Detection of Sudden Change in Propagation Delay Time

As one example of an abnormality related to time synchronization, the detection unit 64 of the switching device 101 detects a sudden change in the data propagation delay time Td1 between the master functional unit 111A and the switching device 101.

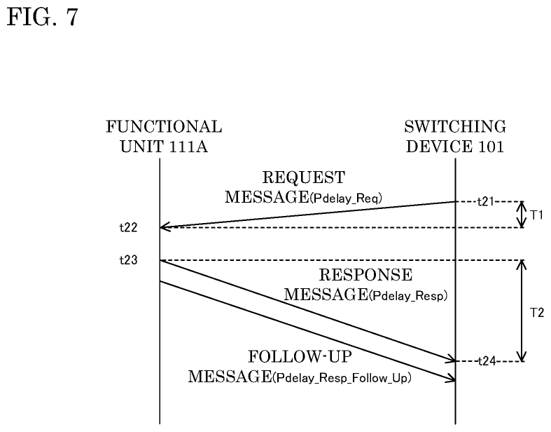

FIG. 7 is a diagram illustrating an example of the case where a sudden change occurs in the data propagation delay time between the master functional unit and the switching device according to this embodiment of the present disclosure.

As shown in FIGS. 2 and 7, here, the switching device 101 transmits a request message to the functional unit 111A at a time t21, the functional unit 111A receives the request message at a time t22, and the functional unit 111A transmits a response message to the switching device 101 at a time t23. Furthermore, the functional unit 111A transmits a follow-up message to the switching device 101 after transmitting the response message.

Also, it is assumed that for some sort of reason, the propagation delay time Td1 has suddenly become longer in the period from the time t22 to the time t23, that is to say, a period T2 from the time t23 to the time t24 has become longer than a period T1 from the time t21 to the time t22.

As described above, the control unit 62 shown in FIG. 2 receives the response message and the follow-up message via the communication port 54A, and notifies the time synchronization unit 52 of the time t22 included in the response message and the time t23 included in the follow-up message. The control unit 62 also notifies the time synchronization unit 52 of the transmission time t21 of the request message and the reception time t24 of the response message.

As described above, the processing unit 63 of the time synchronization unit 52 uses the notified times t21, t22, t23, and t24 to calculate the propagation delay time Td1=((t24−t21)−(t23−t22))/2. However, since the above formula assumes that the period T1 and the period T2 are the same, an erroneous propagation delay time Td1 will be obtained if there is a difference between the period T1 and the period T2.

For this reason, the detection unit 64 of the time synchronization unit 52 determines whether or not a sudden change has occurred in the propagation delay time Td1 based on the times t21, t22, t23, and t24 notified from the control unit 62.

Specifically, it is assumed that the period T2 from the time t23 to the time t24 is longer than the period T1 from the time t21 to the time t22 by a predetermined value or more. In this case, the detection unit 64 determines that the propagation delay time Td1 has suddenly increased, and that a delay has occurred in the transmission of the response message between the switching device 101 and the functional unit 111A.

The detection unit 64 then notifies the recording unit 65 that a delay has occurred in the transmission of the response message, as the detection result. At this time, the detection unit 64 also includes, in the detection result, the time at which it was determined that a delay occurred in the transmission of the response message, for example.

Similarly to the detection unit 64 of the switching device 101 described above, the detection unit 92B of the slave functional unit 111B detects whether or not a sudden change has occurred in the data propagation delay time Td2 between the switching device 101 and the functional unit 111B, for example.

In the case of determining that the propagation delay time Td2 has suddenly increased, and that a delay occurred in the transmission of the response message between the switching device 101 and the functional unit 111B, the detection unit 92B notifies the recording unit 93B that a delay has occurred in the transmission of the response message, as the detection result.

### (b) Detection of Interruption in Data Transmitted Between Devices

As an example of an abnormality related to time synchronization, the detection unit 64 of the switching device 101 detects an interruption in data transmitted between the switching device 101 and the functional unit 111B.

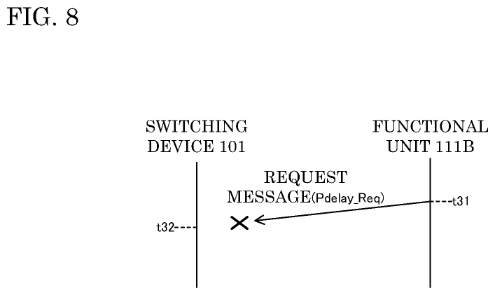

FIG. 8 is a diagram illustrating an example of a case where an interruption has occurred in data transmitted between a functional unit and the switching device according to this embodiment of the present disclosure.

As shown in FIGS. 2 and 8, it is assumed here that a request message transmitted from functional unit 111B to the switching device 101 at a time t31 was interrupted and not received by the switching device 101. In this case, a response message and a follow-up message are not transmitted by the switching device 101.

Also, the detection unit 64 of the switching device 101 monitors the relay unit 51 to monitor the reception status, in the switching device 101, of the request message from the functional unit 111B. For example, it is then assumed that after the switching device 101 and the functional unit 111B have exchanged predetermined information for starting communication at the startup of the vehicle-mounted network system 301, a situation in which a request message from the functional unit 111B does not arrive at the switching device 101 has continued for a predetermined time or longer. In this case, the detection unit 64 determines that the request message from the functional unit 111B was interrupted.

The detection unit 64 then notifies the recording unit 65 that the request message from the functional unit 111B was interrupted, as a detection result. At this time, the detection unit 64 also includes, in the detection result, the time at which it was determined that the request message from the functional unit 111B was interrupted, for example.

Similarly to the detection unit 64 of the switching device 101 described above, the detection unit 92A of the master functional unit 111A determines whether or not an interruption occurred in data transmitted between the functional unit 111A and the switching device 101, for example. In the case of determining that a data interruption occurred, the detection unit 92A notifies the recording unit 93A of the fact that the data interruption occurred, as a detection result.

### (c) Detection of Message Transmission Delay

Referring again to FIG. 2, as an example of an abnormality related to time synchronization, the detection unit 64 of the switching device 101 detects that a delay has occurred in the transmission of a message from the switching device 101.

More specifically, the processing unit 63 is configured to periodically transmit a request message to the functional unit 111A. In this case, the detection unit 64 monitors the relay unit 51, for example, and in the case where a situation in which the processing unit 63 does not transmit a new request message has continued for a predetermined time or longer, it is determined that a request message transmission delay has occurred.

In this case, the detection unit 64 notifies the recording unit 65 that a request message transmission delay has occurred, as a detection result. At this time, the detection unit 64 also includes, in the detection result, the time at which it was determined that a request message transmission delay has occurred, for example.

The detection units 92 of the functional unit 111A and the functional unit 111B each determine whether or not a delay has occurred in the transmission of a message from the corresponding functional unit 111, similarly to the detection unit 64 of the switching device 101 described above. In the case of determining that a delay has occurred in the transmission of a message from the corresponding functional unit 111, the detection unit 92 notifies the recording unit 93 that the message transmission delay has occurred, as the detection result.

### (d) Detection of Problem in Timestamp Function

Here, as described above, the control unit 62 checks the count value of the counter (not shown) provided in the switching device 101, and notifies the time synchronization unit 52 of the message transmission time or the message reception time. In other words, the control unit 62 notifies the time with use of a timestamp function, and cannot notify the time synchronization unit 52 of the correct time if a problem has occurred with the timestamp function.

For this reason, as an example of an abnormality related to time synchronization, the detection unit 64 of the switching device 101 detects that a problem has occurred with the timestamp function of the switching device 101.

Specifically, the detection unit 64 periodically or irregularly checks whether the counter is operating normally, for example. In the case where the counter is not operating normally, the detection unit 64 notifies the recording unit 65 that a problem has occurred with the timestamp function, as a detection result. At this time, the detection unit 64 also includes, in the detection result, the time at which it was determined that a problem has occurred with the timestamp function, for example.

The detection units 92 of the functional unit 111A and the functional unit 111B each determine whether or not a problem has occurred with the timestamp function of the corresponding functional unit 111, similarly to the detection unit 64 of the switching device 101 described above. In the case of determining that a problem has occurred with the timestamp function of the corresponding functional unit 111, the detection unit 92 notifies the recording unit 93 that a problem has occurred with the timestamp function, as the detection result.

Note that the detection unit 64 or the detection unit 92 may be configured to detect another type of abnormality related to time synchronization instead of or in addition to the abnormalities described in sections (a) to (d) above. Also, the detection unit 64 or the detection unit 92 may be configured to detect any one or more of the abnormalities described in sections (a) to (d) above.

### Recording of Detection Result

The recording unit 65 of the switching device 101 stores information regarding an abnormality detected by the detection unit 64 in the storage unit 53, based on a detection result notified from the detection unit 64. Also, the recording unit 93 of the functional unit 111 stores information regarding an abnormality detected by the detection unit 92 in the storage unit 83, based on a detection result notified from the detection unit 92.

More specifically, based on the notified detection result, the recording unit 65 and the recording unit 93 specify the time when the abnormality occurred, the location where the abnormality occurred, the cause of the abnormality, and the like. The storage unit 53 and the storage unit 83 also store an error code list Ta2 indicating the correspondence relationship between abnormality occurrence locations, abnormality causes, and error codes.

The recording unit 65 references the error code list Ta2 stored in the storage unit 53, and stores the error code that corresponds to the specified occurrence location and cause in the storage unit 53. Also, the recording unit 93 references the error code list Ta2 stored in the storage unit 83, and stores the error code that corresponds to the specified occurrence location and cause in the storage unit 83.

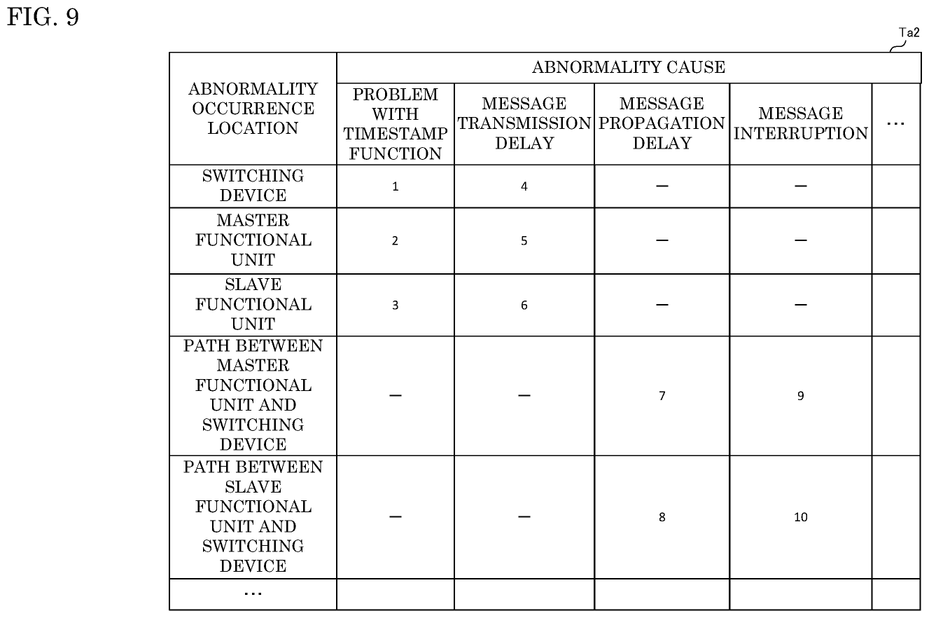

FIG. 9 is a diagram showing an example of the error code list stored in the storage units of the switching device and the functional unit according to this embodiment of the present disclosure.

Specifically, as shown in FIG. 9, in the error code list Ta2, the error code is “1” in the case where the switching device 101 is the location where the abnormality occurred and furthermore a timestamp function problem is the cause of the abnormality. In the error code list Ta2, the error code is “2” in the case where the master functional unit 111A is the location where the abnormality occurred and furthermore a timestamp function problem is the cause of the abnormality. In the error code list Ta2, the error code is “3” in the case where the slave functional unit 111B is the location where the abnormality occurred and furthermore a timestamp function problem is the cause of the abnormality.

In the error code list Ta2, the error code is “4” in the case where the switching device 101 is the location where the abnormality occurred and furthermore a message transmission delay is the cause of the abnormality. In the error code list Ta2, the error code is “5” in the case where the master functional unit 111A is the location where the abnormality occurred and furthermore a message transmission delay is the cause of the abnormality. In the error code list Ta2, the error code is “6” in the case where the slave functional unit 111B is the location where the abnormality occurred and furthermore a message transmission delay is the cause of the abnormality.

In the error code list Ta2, the error code is “7” in the case where the location where the abnormality occurred is a data propagation path between the master functional unit 111A and the switching device 101 and furthermore a message propagation delay is the cause of the abnormality. In the error code list Ta2, the error code is “8” in the case where the location where the abnormality occurred is a data propagation path between the slave functional unit 111B and the switching device 101 and furthermore a message propagation delay is the cause of the abnormality.

In the error code list Ta2, the error code is “9” in the case where the location where the abnormality occurred is a data propagation path between the master functional unit 111A and the switching device 101 and furthermore a message interruption is the cause of the abnormality. In the error code list Ta2, the error code is “10” in the case where the location where the abnormality occurred is a data propagation path between the slave functional unit 111B and the switching device 101 and furthermore a message interruption is the cause of the abnormality.

### Specific Example 1 of Recorded Information

In one example, it is assumed that the recording unit 65 of the switching device 101 receives a detection result indicating that a delay occurred in the transmission of a response message between the switching device 101 and the functional unit 111A. In this case, the recording unit 65 specifies the data propagation path between the master functional unit 111A and the switching device 101 as the location where the abnormality occurred. The recording unit 65 also specifies a message propagation delay as the cause of the abnormality. The recording unit 65 also specifies the time included in the detection result as the time when the abnormality occurred.

The recording unit 65 references the error code list Ta2 and stores, in the storage unit 53, the error code “7” corresponding to the specified occurrence location and cause, as well as the time when the abnormality occurred. Note that the time when the abnormality occurred is stored with a sufficient data bit length for recording up to nanoseconds, for example.

### Specific Example 2 of Recorded Information

As another example, it is assumed that the recording unit 65 of the switching device 101 receives a detection result indicating that a request message from the functional unit 111B was interrupted. In this case, the recording unit 65 specifies the data propagation path between the slave functional unit 111B and the switching device 101 as the location where the abnormality occurred. The recording unit 65 also specifies a message interruption as the cause of the abnormality. The recording unit 65 also specifies the time included in the detection result as the time when the abnormality occurred.

The recording unit 65 references the error code list Tat, and stores, in the storage unit 53, the error code “10” corresponding to the specified occurrence location and cause, as well as the time when the abnormality occurred.

### Specific Example 3 of Recorded Information

As another example, it is assumed that the recording unit 65 of the switching device 101 receives a detection result indicating that a delay occurred in the transmission of a request message from the switching device 101. In this case, the recording unit 65 specifies the switching device 101 as the location where the abnormality occurred. The recording unit 65 also specifies a message transmission delay as the cause of the abnormality. The recording unit 65 also specifies the time included in the detection result as the time when the abnormality occurred.

The recording unit 65 references the error code list Ta2 and stores, in the storage unit 53, the error code “4” corresponding to the specified occurrence location and cause, as well as the time of occurrence of the abnormality.

### Specific Example 4 of Recorded Information

As another example, it is assumed that the recording unit 65 of the switching device 101 receives a detection result indicating that a problem has occurred with the timestamp function in the switching device 101. In this case, the recording unit 65 specifies the switching device 101 as the location where the abnormality occurred. The recording unit 65 also specifies a message transmission delay as the cause of the abnormality. The recording unit 65 also specifies the time included in the detection result as the time when the abnormality occurred.

The recording unit 65 references the error code list Ta2 and stores, in the storage unit 53, the error code “1” corresponding to the specified occurrence location and cause, as well as the time when the abnormality occurred.

The recording unit 93 of the functional unit 111 performs operations similar to those performed by the recording unit 65 of the switching device 101 as described above.

Note that in the switching device 101 according to this embodiment of the present disclosure, the detection unit 64 and the recording unit 65 are included in the time synchronization unit 52. In other words, the detection unit 64 is configured to detect only an abnormality related to time synchronization, but the present disclosure is not limited to this. For example, the detection unit 64 and the recording unit 65 may be provided outside the time synchronization unit 52, and be configured to detect an abnormality other than an abnormality related to time synchronization and store the detection result in the storage unit 53.

Also, in the functional unit 111 according to this embodiment of the present disclosure, the detection unit 92 and the recording unit 93 are included in the time synchronization unit 82. In other words, the detection unit 92 is configured to detect only an abnormality related to time synchronization, but the present disclosure is not limited to this. For example, the detection unit 92 and the recording unit 93 may be provided outside the time synchronization unit 82, and be configured to detect an abnormality other than an abnormality related to time synchronization and store the detection result in the storage unit 83.

Moreover, the switching device 101 is not required to include the recording unit 65. In this case, instead of notifying the recording unit 65 of the detection result, the detection unit 64 notifies an external server of the detection result, for example. Also, the functional unit 111 is not required to include the recording unit 93. In this case, instead of notifying the recording unit 93 of the detection result, the detection unit 92 notifies a server or the like, which is outside the vehicle 1, of the detection result, for example.

### Operation Flow

The following describes operations when the master functional unit 111A, the switching device 101, and the slave functional unit 111B update the propagation delay time and detect an abnormality related to time synchronization in the vehicle-mounted network system 301, with reference to the drawings.

The devices in the vehicle-mounted network system 301 each have a computer that includes a memory, and in each of such devices, a computation processing unit such as a CPU in the computer reads out, from the memory, a program that includes part or all of the steps of the sequence described below, and executes the program. The programs executed by the devices can be installed from an external source. The programs executed by the devices are distributed in a state of being stored in recording media or distributed via a communication line.

### Operation Procedure for Updating of Propagation Delay Time and Detection of Abnormality Related to Time Synchronization

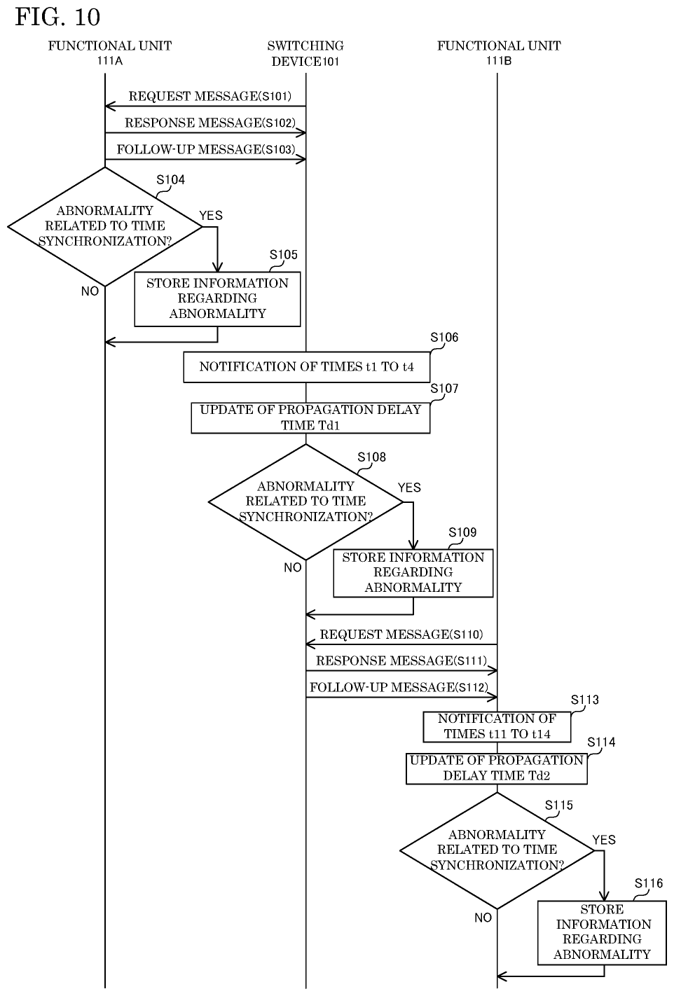

FIG. 10 is a diagram showing a sequence of updating of the propagation delay time and detection of an abnormality related to time synchronization, performed by a plurality of vehicle-mounted devices in the vehicle-mounted network system according to this embodiment of the present disclosure.

As shown in FIG. 10, first, the processing unit 63 of the switching device 101 transmits a request message for requesting time information to the functional unit 111A via the relay unit 51 and the communication port 54A (step S101).

Next, the processing unit 91A of the functional unit 111A transmits a response message to the switching device 101 in response to the request message transmitted from the switching device 101. At this time, the functional unit 111A also transmits the reception time t2 of the request message in the response message (step S102).

Next, after transmitting the response message, the processing unit 91A of the functional unit 111A transmits a follow-up message that includes the transmission time t3 of the response message to the switching device 101 (step S103).

Next, the detection unit 92A of the functional unit 111A performs detection regarding an abnormality related to time synchronization (step S104).

Next, in the case of detecting an abnormality related to time synchronization such as a response message transmission delay (“YES” in step S104), the detection unit 92A notifies the recording unit 93A of the detection result. The recording unit 93A then stores, in the storage unit 83A, information regarding the abnormality indicated by the detection result notified from the detection unit 92A (step S105).

On the other hand, in the case where an abnormality related to time synchronization has not occurred (“NO” in step S104), the detection unit 92A does not notify the recording unit 93A of the detection result, for example.

Next, the control unit 62 of the switching device 101 receives the response message and the follow-up message that were transmitted from the functional unit 111A and notifies the processing unit 63 of the time t2 included in the response message and the time t3 included in the follow-up message. The control unit 62 also notifies the processing unit 63 of the transmission time t1 of the request message and the reception time t4 of the response message (step S106).

The processing unit 63 updates the data propagation delay time Td1 between the functional unit 111A and the switching device 101 based on the times t1, t2, t3, and t4 notified from the control unit 62 (step S107).

Next, the detection unit 64 of the switching device 101 performs detection regarding an abnormality related to time synchronization (step S108).

Next, in the case of detecting an abnormality related to time synchronization such as a response message transmission delay (“YES” in step S108), the detection unit 64 notifies the recording unit 65 of the detection result. The recording unit 65 stores, in the storage unit 53, information regarding the abnormality indicated by the detection result notified from the detection unit 64 (step S109).

On the other hand, in the case where an abnormality related to time synchronization has not occurred (“NO” in step S108), the detection unit 64 does not notify the recording unit 65 of the detection result, for example.

Next, the processing unit 91B of the functional unit 111B transmits a request message for requesting time information to the switching device 101 via the communication unit 81B and the communication port 84B (step S110).

Next, when the request message transmitted from the functional unit 111B is received via the communication port 54B and the control unit 62, the processing unit 63 of the switching device 101 transmits a response message, in response to the request message, to the functional unit 111B via the relay unit 51 and the communication port 54B. At this time, the processing unit 63 also transmits the reception time t12 of the request message in the response message (step S111).

Next, after transmitting the response message, the processing unit 63 transmits a follow-up message that includes the transmission time t13 of the response message to the functional unit 111B via the relay unit 51 (step S112).

Next, when the response message and the follow-up message that were transmitted from the switching device 101 are received via the communication port 84B, the communication unit 81B of the functional unit 111B notifies the time synchronization unit 82B of the time t12 included in the response message and the time t13 included in the follow-up message. The communication unit 81 also notifies the time synchronization unit 82B of the transmission time t11 of the request message and the reception time t14 of the response message (step S113).

The processing unit 91B of the time synchronization unit 82B updates the data propagation delay time Td2 between the switching device 101 and the functional unit 111B based on the times t11, t12, t13, and t14 notified from the communication unit 81B (step S114).

Next, the detection unit 92B of the functional unit 111B performs detection regarding an abnormality related to time synchronization (step S115).

Next, in the case of detecting an abnormality related to time synchronization such as a response message transmission delay (“YES” in step S115), the detection unit 92B notifies the recording unit 93B of the detection result. The recording unit 93B then stores, in the storage unit 83B, information regarding the abnormality indicated by the detection result notified from the detection unit 92B (step S116).

On the other hand, in the case where an abnormality related to time synchronization has not occurred (“NO” in step S115), the detection unit 92B does not notify the recording unit 93B of the detection result, for example.

Note that the operations of steps S101 to S103 may be performed after the operations of steps S104 and S105. Also, the operations of steps S101 to S103 and the operations of steps S104 and S105 may be performed in parallel.

The operations of steps S106 and S107 may be performed after the operations of steps S108 and S109. Also, the operations of steps S106 and S107 and the operations of steps S108 and S109 may be performed in parallel.

The operations of steps S110 to S114 may be performed after the operations of steps S115 and S116. Also, the operations of steps S110 to S114 and the operations of steps S115 and S116 may be performed in parallel.

### Operation Procedure When Performing Time Correction

The following describes operations when the switching device 101 and the slave functional unit 111B perform time correction in the vehicle-mounted network system 301, with reference to the drawings.

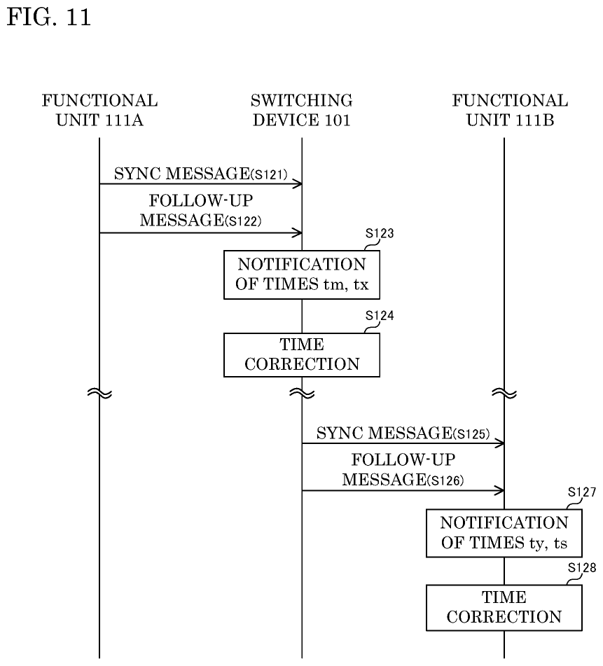

FIG. 11 is a diagram showing a sequence of time correction performed by a plurality of vehicle-mounted devices in the vehicle-mounted network system according to this embodiment of the present disclosure.

As shown in FIG. 11, first, the processing unit 91A of the functional unit 111A transmits a Sync message to the switching device 101 (step S121).

Next, the processing unit 91A transmits a follow-up message that includes the transmission time tm of the Sync message to the switching device 101 (step S122).

Next, when the Sync message and the follow-up message that were transmitted from the functional unit 111A are received via the communication port 54A, the control unit 62 of the switching device 101 notifies the time synchronization unit 52 of the time tm included in the follow-up message and the reception time tx of the Sync message (step S123).

Next, the processing unit 63 of the time synchronization unit 52 calculates a time difference Tx1=tm−Td1−tx between the time in the functional unit 111A and the time in the switching device 101, based on the times tm and tx notified from the control unit 62 and the propagation delay time Td1 stored in the storage unit 53.

The processing unit 63 corrects the time in the switching device 101 using the calculated time difference Tx1. Accordingly, time synchronization is achieved between the functional unit 111A and the switching device 101 (step S124).

Next, the processing unit 63 of the switching device 101 transmits a Sync message to the functional unit 111B via the communication port 54B (step S125).

Next, the processing unit 63 transmits a follow-up message that includes the transmission time ty of the Sync message to the functional unit 111B via the communication port 54B (step S126).

Next, when the Sync message and the follow-up message that were transmitted from the switching device 101 are received via the communication port 84B, the communication unit 81B of the functional unit 111B notifies the time synchronization unit 82B of the time ty included in the follow-up message and the reception time ts of the Sync message (step S127).

Next, the processing unit 91B of the time synchronization unit 82B calculates a time difference Tx2=ty−Td2−ts between the time in the switching device 101 and the time in the functional unit 111B, based on the times ty and ts notified from the communication unit 81B and the propagation delay time Td2 stored in the storage unit 83B.

The processing unit 91B then corrects the time in the functional unit 111B using the calculated time difference Tx2. Accordingly, time synchronization is achieved between the functional unit 111B and the switching device 101, and as a result, time synchronization is achieved between the functional unit 111B and the functional unit 111A (step S128).

Note that the operations of steps S121 to S124 may be performed after the operations of steps S125 and S128. Also, the operations of steps S121 to S124 and the operations of steps S125 to S128 may be performed in parallel.

By the way, for example, the data propagation delay time between vehicle-mounted devices in a vehicle-mounted network is periodically updated in accordance with a protocol defined by a standard such as IEEE 802.1, and the updated propagation delay time is used in order to perform time synchronization among the vehicle-mounted devices.

However, an abnormality related to time synchronization, such as a sudden change in the data propagation delay time between vehicle-mounted devices, can possibly occur, and in such a case, a problem such as a decrease in the precision of time synchronization may occur.

In contrast, in the switching device 101, which is a vehicle-mounted device according to this embodiment of the present disclosure, the processing unit 63 transmits, to another device, which is another vehicle-mounted device, request information for requesting time information used for updating the data propagation delay time between the other device and the switching device 101. The processing unit 63 updates the propagation delay time based on time information transmitted from the other device, and performs time synchronization with the other device based on the updated propagation delay time. The detection unit 64 detects an abnormality related to time synchronization, and acquires information regarding the detected abnormality.

Also, in the slave functional unit 111B, which is a vehicle-mounted device according to this embodiment of the present disclosure, the processing unit 91B transmits, to another device, which is another vehicle-mounted device, request information for requesting time information used for updating the data propagation delay time between the other device and the functional unit 111B. The processing unit 91B updates the propagation delay time based on time information transmitted from the other device, and performs time synchronization with the other device based on the updated propagation delay time. The detection unit 92B detects an abnormality related to time synchronization, and acquires information regarding the detected abnormality.

Also, in a time synchronization method performed by the switching device 101 according to this embodiment of the present disclosure, first, the processing unit 63 transmits, to another device that is another vehicle-mounted device, request information for requesting time information used for updating the data propagation delay time between the other device and the switching device 101. Next, the processing unit 63 receives time information transmitted from the other device. Next, the processing unit 63 updates the propagation delay time based on the received time information. Next, the processing unit 63 performs time synchronization with the other device based on the updated propagation delay time. Next, the detection unit 64 detects an abnormality related to time synchronization, and acquires information regarding the detected abnormality.

Also, in a time synchronization method performed by the slave functional unit 111B according to this embodiment of the present disclosure, first, the processing unit 91B transmits, to another device that is another vehicle-mounted device, request information for requesting time information used for updating the data propagation delay time between the other device and the functional unit 111B. Next, the processing unit 91B receives time information transmitted from the other device. Next, the processing unit 91B updates the propagation delay time based on the received time information. Next, the processing unit 91B performs time synchronization with the other device based on the updated propagation delay time. Next, the detection unit 92B detects an abnormality related to time synchronization, and acquires information regarding the detected abnormality.

In this way, with the configuration for detecting an abnormality related to time synchronization, it is possible to recognize the occurrence of an abnormality, and to take a measure such as quickly performing processing to resolve the cause of the abnormality.

Accordingly, with the vehicle-mounted device and the time synchronization method according to this embodiment of the present disclosure, time synchronization between vehicle-mounted devices can be performed more stably.

Also, time synchronization can be performed between the master functional unit 111A which is a vehicle-mounted device according to this embodiment of the present disclosure, and another device, which is another vehicle-mounted device, based on the data propagation delay time between the functional unit 111A and the other device. In the functional unit 111A the processing unit 91A receives request information for requesting time information used for updating the propagation delay time, from the other device, and transmits the time information to the other device. The detection unit 92A detects an abnormality related to time synchronization, and acquires information regarding the detected abnormality.

Also, in the time synchronization method performed by the master functional unit 111A according to this embodiment of the present disclosure, first, the processing unit 91A receives request information for requesting time information used for updating propagation delay time, from another device, which is another vehicle-mounted device. Next, the processing unit 91A transmits time information to the other device. Next, the detection unit 92A detects an abnormality related to time synchronization, and acquires information regarding the detected abnormality.

In this way, with the configuration for detecting an abnormality related to time synchronization, it is possible to recognize the occurrence of an abnormality, and to take a measure such as quickly performing processing to resolve the cause of the abnormality.

Accordingly, with the vehicle-mounted device and the time synchronization method according to this embodiment of the present disclosure, time synchronization between vehicle-mounted devices can be performed more stably.

Also, with the configuration for detecting an abnormality related to time synchronization in the functional unit 111A that is the transmission source of time information, that is to say in the vehicle-mounted device that holds the reference time in the vehicle-mounted network system 301, it is possible to more reliably detect an abnormality related to time synchronization.

The foregoing embodiments are to be construed in all respects as illustrative and not restrictive. The scope of the present disclosure is defined by the claims rather than the description above, and is intended to include all modifications within the meaning and scope of the claims and equivalents thereof.

The above description includes the features described in the following supplementary note.

### Supplementary Note 1

A vehicle-mounted device including: a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and a detection unit configured to detect an abnormality related to time synchronization, and acquire information regarding the detected abnormality, wherein in addition to detecting the abnormality related to time synchronization, the detection unit is further configured to detect an abnormality other than the abnormality related to time synchronization, the vehicle-mounted device further includes a recording unit configured to store, in a storage unit, the information regarding the abnormality detected by the detection unit, and the recording unit stores, as the information regarding the abnormality in the storage unit, at least one of an abnormality occurrence time, an abnormality occurrence location, and an abnormality cause.

### Supplementary Note 2

A vehicle-mounted device, in which time synchronization is performed between the vehicle-mounted device and another device that is another vehicle-mounted device based on a data propagation delay time between the vehicle-mounted device and the other device, the vehicle-mounted device including: a processing unit configured to receive, from the other device, request information that requests time information used for updating the propagation delay time, and transmit the time information to the other device; and a detection unit configured to detect an abnormality related to time synchronization, and acquire information regarding the detected abnormality, wherein the vehicle-mounted device holds a reference time in a vehicle-mounted network,
in addition to detecting the abnormality related to time synchronization, the detection unit is further configured to detect an abnormality other than the abnormality related to time synchronization, the vehicle-mounted device further includes a recording unit configured to store, in a storage unit, the information regarding the abnormality detected by the detection unit, and the recording unit stores, as the information regarding the abnormality in the storage unit, at least one of an abnormality occurrence time, an abnormality occurrence location, and an abnormality cause.

1. A vehicle-mounted device comprising:
a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and
a detection unit configured to detect an abnormality related to time synchronization, and acquire information regarding the detected abnormality,
wherein the detection unit can detect, as the abnormality related to time synchronization, an abnormality related to transmission of at least either the request information or the time information, and an abnormality related to a timestamp function, and
the vehicle-mounted device further comprises:
a recording unit configured to store, in a storage unit of the vehicle-mounted device, the information regarding the abnormality detected by the detection unit, the information also enabling specifying a type of the abnormality.

2. A vehicle-mounted device, in which time synchronization is performed between the vehicle-mounted device and another device that is another vehicle-mounted device based on a data propagation delay time between the vehicle-mounted device and the other device, the vehicle-mounted device comprising:
a processing unit configured to receive, from the other device, request information that requests time information used for updating the propagation delay time, and transmit the time information to the other device; and
a detection unit configured to detect an abnormality related to time synchronization, and acquire information regarding the detected abnormality,
wherein the detection unit can detect, as the abnormality related to time synchronization, an abnormality related to transmission of at least either the request information or the time information, and an abnormality related to a timestamp function, and
the vehicle-mounted device further comprises:
a recording unit configured to store, in a storage unit of the vehicle-mounted device, the information regarding the abnormality detected by the detection unit, the information also enabling specifying a type of the abnormality.

3. The vehicle-mounted device according to claim 1,
wherein the detection unit detects, as the abnormality related to time synchronization, a delay or an interruption in transmission of at least either the request information or the time information.

4. An abnormality detecting method performed in a vehicle-mounted device, comprising the steps of:
transmitting, to another device that is another vehicle-mounted device, request information that requests time information used for updating a data propagation delay time between the vehicle-mounted device and the other device;
receiving the time information transmitted from the other device;
updating the propagation delay time based on the received time information;
performing time synchronization with the other device based on the updated propagation delay time; and
detecting an abnormality related to time synchronization, and acquiring information regarding the detected abnormality,
wherein in the abnormality detecting step, an abnormality related to transmission of at least either the request information or the time information, and an abnormality related to a timestamp function can be detected as the abnormality related to time synchronization, and
the abnormality detecting method further comprises the step of:
storing, in a storage unit of the vehicle-mounted device, the information regarding the detected abnormality, the information also enabling specifying a type of the abnormality.

5. An abnormality detecting method performed in a vehicle-mounted device, in which time synchronization is performed between the vehicle-mounted device and another device that is another vehicle-mounted device based on a data propagation delay time between the vehicle-mounted device and the other device, the abnormality detecting method comprising the steps of:
receiving, from the other device, request information that requests time information used for updating the propagation delay time;
transmitting the time information to the other device; and
detecting an abnormality related to time synchronization, and acquiring information regarding the detected abnormality,
wherein in the abnormality detecting step, an abnormality related to transmission of at least either the request information or the time information, and an abnormality related to a timestamp function can be detected as the abnormality related to time synchronization, and
the abnormality detecting method further comprises the step of:
storing, in a storage unit of the vehicle-mounted device, the information regarding the detected abnormality, the information also enabling specifying a type of the abnormality.

6. An abnormality detecting program used in a vehicle-mounted device, the abnormality detecting program causing a computer to function as:
a processing unit configured to transmit, to another device that is another vehicle-mounted device, request information that requests time information used for updating a data propagation delay time between the vehicle-mounted device and the other device, update the propagation delay time based on the time information transmitted from the other device, and perform time synchronization with the other device based on the updated propagation delay time; and
a detection unit configured to detect an abnormality related to time synchronization, and acquire information regarding the detected abnormality,
wherein the detection unit can detect, as the abnormality related to time synchronization, an abnormality related to transmission of at least either the request information or the time information, and an abnormality related to a timestamp function, and
the abnormality detecting program further causes the computer to function as:
a recording unit configured to store, in a storage unit of the vehicle-mounted device, the information regarding the abnormality detected by the detection unit, the information also enabling specifying a type of the abnormality.

7. An abnormality detecting program used in a vehicle-mounted device, in which time synchronization is performed between the vehicle-mounted device and another device that is another vehicle-mounted device based on a data propagation delay time between the vehicle-mounted device and the other device, the abnormality detecting program causing a computer to function as:
a processing unit configured to receive, from the other device, request information that requests time information used for updating the propagation delay time, and transmit the time information to the other device; and
a detection unit configured to detect an abnormality related to time synchronization, and acquire information regarding the detected abnormality,
wherein the detection unit can detect, as the abnormality related to time synchronization, an abnormality related to transmission of at least either the request information or the time information, and an abnormality related to a timestamp function, and
the abnormality detecting program further causes the computer to function as:
a recording unit configured to store, in a storage unit of the vehicle-mounted device, the information regarding the abnormality detected by the detection unit, the information also enabling specifying a type of the abnormality.

8. A vehicle-mounted network system comprising:
a first vehicle-mounted device; and
a second vehicle-mounted device,
wherein the first vehicle-mounted device transmits, to the second vehicle-mounted device, request information that requests time information used for updating a data propagation delay time between the first vehicle-mounted device and the second vehicle-mounted device,
the second vehicle-mounted device receives the request information and transmits the time information to the first vehicle-mounted device,
the first vehicle-mounted device updates the propagation delay time based on the time information received from the second vehicle-mounted device, and performs time synchronization with the second vehicle-mounted device based on the updated propagation delay time, and
the first vehicle-mounted device and the second vehicle-mounted device each include a storage unit, detect an abnormality related to time synchronization, and store, in the included storage unit, information regarding the detected abnormality, the information enabling specifying, as an abnormality occurrence location, the first vehicle-mounted device, the second vehicle-mounted device, and a path between the first vehicle-mounted device and the second vehicle-mounted device.

9. An abnormality detecting method in a vehicle-mounted network system including a first vehicle-mounted device and a second vehicle-mounted device that each include a storage unit, the abnormality detecting method comprising the steps of:
the first vehicle-mounted device transmitting, to the second vehicle-mounted device, request information that requests time information used for updating a data propagation delay time between the first vehicle-mounted device and the second vehicle-mounted device;
the second vehicle-mounted device receiving the request information and transmitting the time information to the first vehicle-mounted device;
the first vehicle-mounted device updating the propagation delay time based on the time information received from the second vehicle-mounted device, and performing time synchronization with the second vehicle-mounted device based on the updated propagation delay time;
the first vehicle-mounted device detecting an abnormality related to time synchronization, and storing, in the included storage unit, information regarding the detected abnormality, the information enabling specifying, as an abnormality occurrence location, the first vehicle-mounted device, the second vehicle-mounted device, and a path between the first vehicle-mounted device and the second vehicle-mounted device; and
the second vehicle-mounted device detecting an abnormality related to time synchronization, and storing, in the included storage unit, information regarding the detected abnormality, the information enabling specifying, as an abnormality occurrence location, the first vehicle-mounted device, the second vehicle-mounted device, and a path between the first vehicle-mounted device and the second vehicle-mounted device.

10. The vehicle-mounted device according to claim 2,
wherein the detection unit detects, as the abnormality related to time synchronization, a delay or an interruption in transmission of at least either the request information or the time information.
